(19) United States
(12) Patent Application Publication
(10) Pub. No.: US 2021/0246612 A1
(43) Pub. Date: Aug. 12, 2021

(54) FIBROUS BODY ACCUMULATING DEVICE AND FIBER STRUCTURE PRODUCING DEVICE

(71) Applicant: SEIKO EPSON CORPORATION, Tokyo (JP)

(72) Inventors: Kazuma MIYAZAWA, Shiojiri (JP); Katsuhito GOMI, Matsumoto (JP)

(21) Appl. No.: 17/168,400

(22) Filed: Feb. 5, 2021

(30) Foreign Application Priority Data
Feb. 7, 2020 (JP) 2020-020154

(51) Int. Cl. D21F 1/02

(52) U.S. Cl. CPC D21F 1/026

(57) ABSTRACT

A fibrous body accumulating device includes: a drum having an opening for releasing a material containing fibers and rotating around a central axis; and a first dispersion member disposed in the drum, extending in a direction along the central axis, and dispersing the material in the drum, in which the first dispersion member has a first portion having the material with a high dispersion ability and a second portion having the material with a lower dispersion ability than the first portion, the first portion and the second portion being disposed at different positions in a direction along the central axis.

The present application is based on, and claims priority from JP Application Serial Number 2020-020154, filed Feb. 7, 2020, the disclosure of which is hereby incorporated by reference herein in its entirety.

### BACKGROUND

### 1. Technical Field

The present disclosure relates to a fibrous body accumulating device and a fiber structure producing device.

### 2. Related Art

In recent years, a dry sheet manufacturing apparatus without using water as possible has been proposed. In the sheet manufacturing apparatus, for example, a method of pressurizing accumulations formed by an accumulating device that releases and accumulates fibrous bodies to manufacture a sheet has been known. Examples of the accumulating device include those having a configuration disclosed in JP-A-2004-292959.

The accumulating device disclosed in JP-A-2004-292959 includes a rotating drum having ejection holes, and a supply section supplying fibers into the drum. As the drum rotates, the fibers in the drum are released from the ejection holes and accumulated downward.

However, in the accumulating device of JP-A-2004-292959, the fibers are loosened and insufficiently dispersed in the drum, such that lumps or aggregates of the fibers may be generated. In this case, an amount of fibers released from each ejection hole becomes uneven. As a result, it is difficult to obtain an accumulation having a desired thickness distribution.

### SUMMARY

According to an aspect of the present disclosure, a fibrous body accumulating device includes: a drum having an opening for releasing a material containing fibers and rotating around a central axis; and a first dispersion member disposed in the drum, extending in a direction along the central axis, and dispersing the material in the drum, in which the first dispersion member has a first portion having the material with a high dispersion ability and a second portion having the material with a lower dispersion ability than the first portion, the first portion and the second portion being disposed at different positions in a direction along the central axis.

According to another aspect of the present disclosure, a fiber structure producing device includes: the fibrous body accumulating device of the present disclosure; and a molding section molding an accumulation formed by the fibrous body accumulating device.

### BRIEF DESCRIPTION OF THE DRAWINGS

FIG. 1 is a schematic side view illustrating a fiber structure producing device including a fibrous body accumulating device according to a first embodiment.

FIG. 2 is a longitudinal sectional view of a drum included in the fibrous body accumulating device illustrated in FIG. 1.

FIG. 3 is a perspective view of the drum illustrated in FIG. 2.

FIG. 4 is a cross-sectional view taken along line IV-IV in FIG. 2.

FIG. 5 is a cross-sectional view taken along line V-V in FIG. 2 and is a view illustrating a state in which materials are dispersed.

FIG. 6 is a cross-sectional view taken along line VI-VI in FIG. 2, and is a view illustrating a state in which materials are dispersed.

FIG. 7 is a plan view of a first dispersion member illustrated in FIG. 2.

FIG. 8 is a plan view of the first dispersion member illustrated in FIG. 2, and is a view illustrating a state in which materials are dispersed.

FIG. 9 is a plan view of the first dispersion member illustrated in FIG. 2, and is a view illustrating a state in which materials are dispersed.

FIG. 10 is a view illustrating a thickness distribution of an accumulation formed in a mesh belt shape in a width direction of the accumulation.

FIG. 11 is a plan view of a first dispersion member included in a fibrous body accumulating device according to a second embodiment.

FIG. 12 is a plan view of a first dispersion member included in a fibrous body accumulating device according to a third embodiment.

FIG. 13 is a plan view of a first dispersion member included in a fibrous body accumulating device according to a fourth embodiment.

FIG. 14 is a plan view of a first dispersion member included in a fibrous body accumulating device according to a fifth embodiment.

FIG. 15 is a plan view of a first dispersion member included in a fibrous body accumulating device according to a sixth embodiment.

FIG. 16 is a plan view of a first dispersion member included in a fibrous body accumulating device according to a seventh embodiment.

FIG. 17 is a plan view of a first dispersion member included in a fibrous body accumulating device according to an eighth embodiment.

FIG. 18 is a plan view of a first dispersion member included in a fibrous body accumulating device according to a ninth embodiment.

FIG. 19 is a plan view of a first dispersion member included in a fibrous body accumulating device according to a tenth embodiment.

FIG. 20 is a plan view of a first dispersion member included in a fibrous body accumulating device according to an eleventh embodiment.

FIG. 21 is a plan view of a first dispersion member included in a fibrous body accumulating device according to a twelfth embodiment.

FIG. 22 is a side view of the first dispersion member illustrated in FIG. 21.

FIG. 23 is a perspective view of the first dispersion member included in the fibrous body accumulating device according to a thirteenth embodiment.

FIG. 24 is a perspective view of the first dispersion member included in the fibrous body accumulating device according to a fourteenth embodiment.

### DESCRIPTION OF EXEMPLARY EMBODIMENTS

Hereinafter, a fibrous body accumulating device and a fiber structure producing device of the present disclosure will be described in detail based on preferred embodiments shown in the accompanying drawings.

### First Embodiment

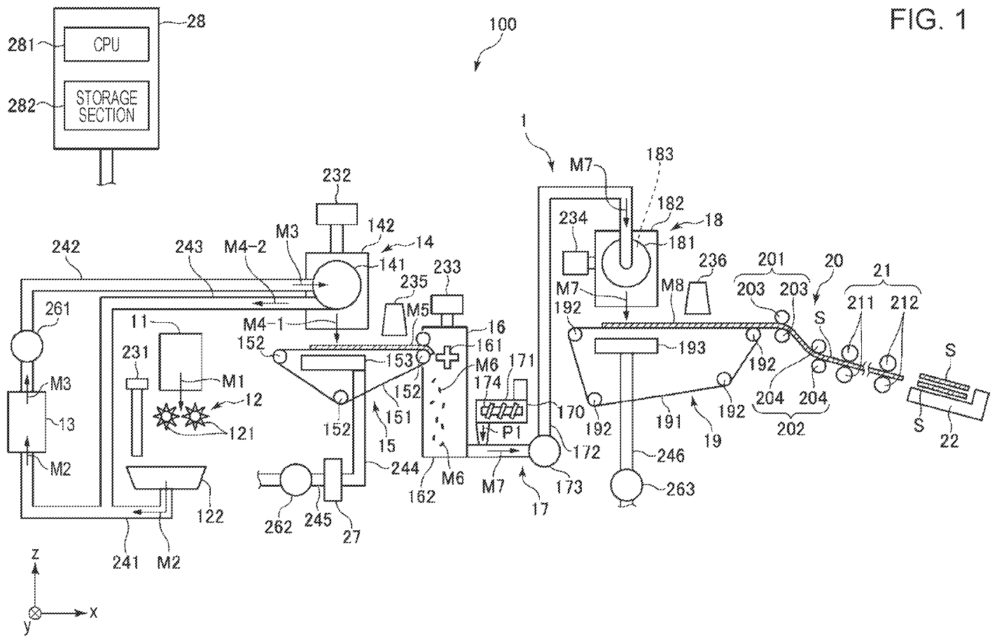

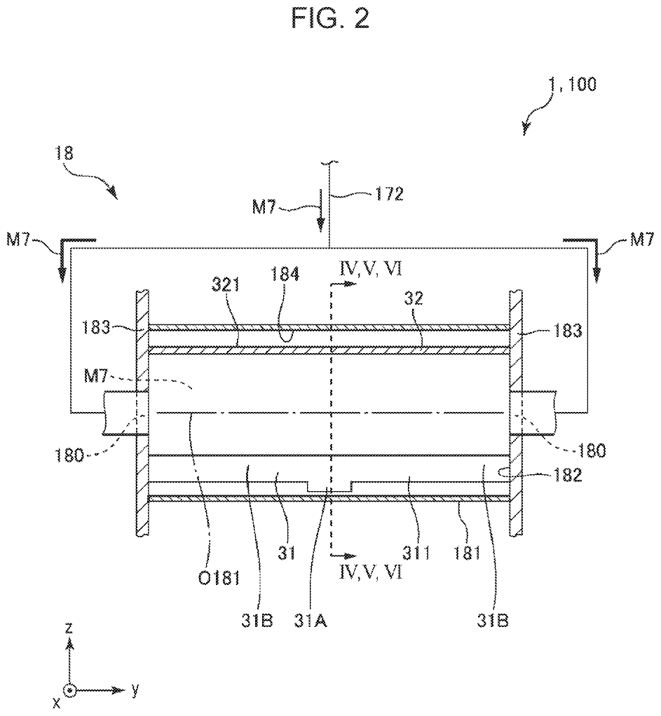

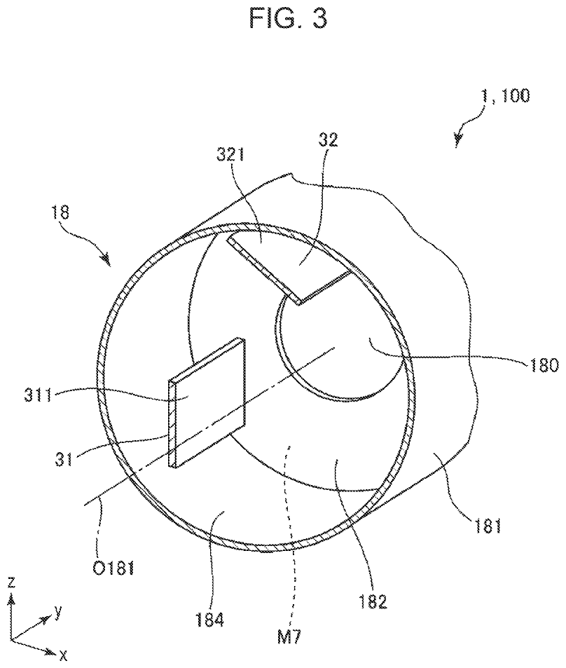

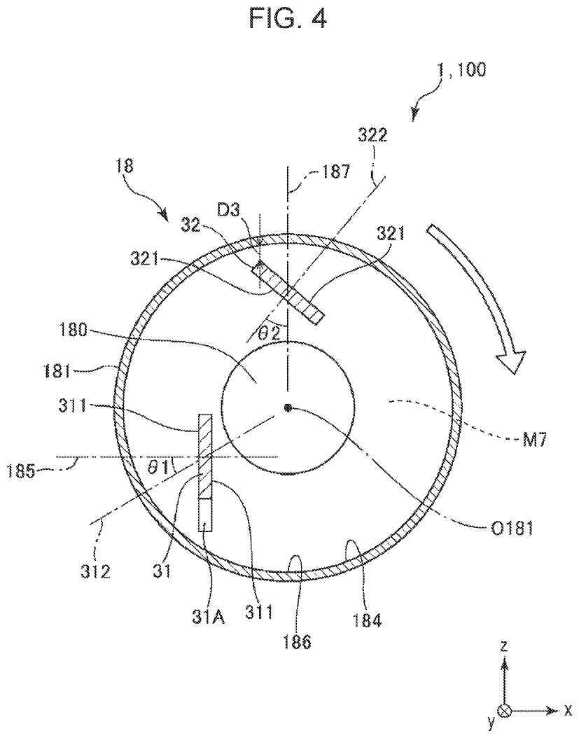

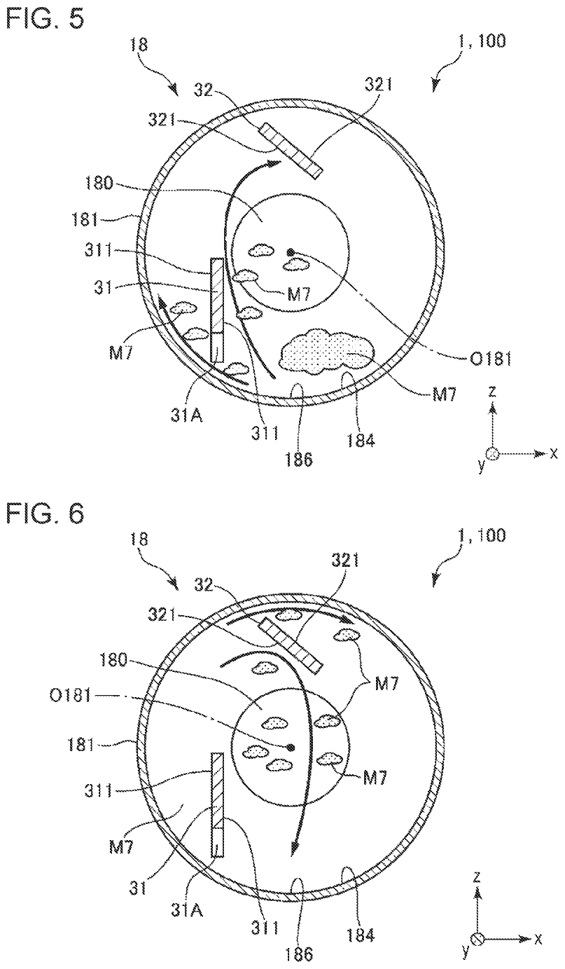

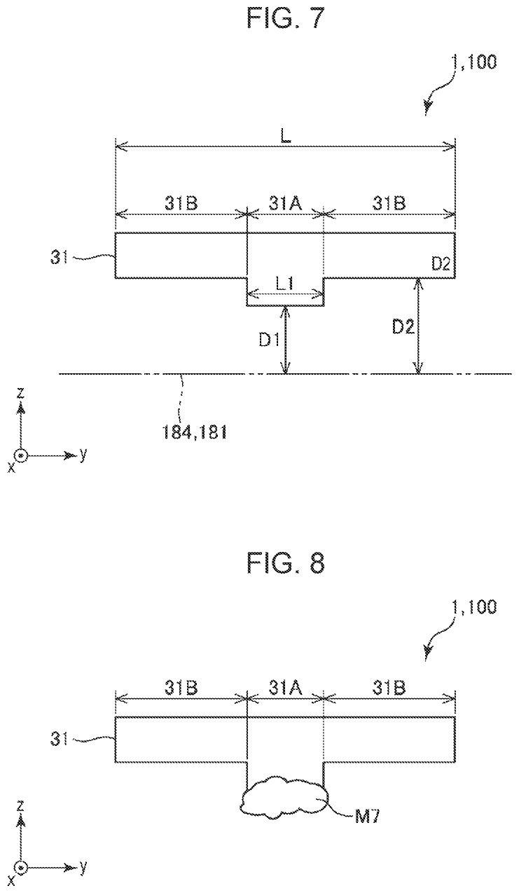

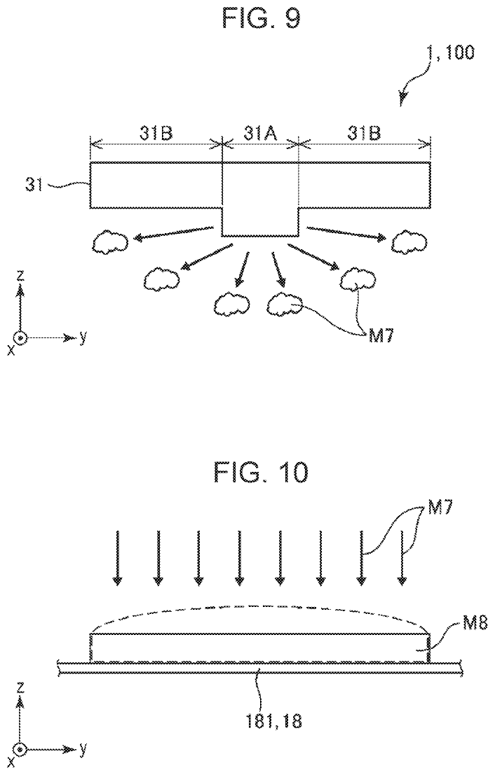

FIG. 1 is a schematic side view illustrating a fiber structure producing device including a fibrous body accumulating device according to a first embodiment. FIG. 2 is a longitudinal sectional view of a drum included in the fibrous body accumulating device illustrated in FIG. 1. FIG. 3 is a perspective view of the drum illustrated in FIG. 2. FIG. 4 is a cross-sectional view taken along line IV-IV in FIG. 2. FIG. 5 is a cross-sectional view taken along line V-V in FIG. 2, and is a view illustrating a state in which materials are dispersed. FIG. 6 is a cross-sectional view taken along line VI-VI in FIG. 2, and is a view illustrating a state in which materials are dispersed. FIG. 7 is a plan view of a first dispersion member illustrated in FIG. 2. FIG. 8 is a plan view of the first dispersion member illustrated in FIG. 2, and is a view illustrating a state in which materials are dispersed. FIG. 9 is a plan view of the first dispersion member illustrated in FIG. 2, and is a view illustrating a state in which materials are dispersed. FIG. 10 is a view illustrating a thickness distribution of an accumulation formed in a mesh belt shape in a width direction of the accumulation.

In the following, for convenience of explanation, as illustrated in FIGS. 1 to 23, three axes orthogonal to each other are referred to as an x axis, a y axis, and a z axis. The xy plane including the x axis and the y axis is horizontal, and the z axis is vertical. The direction in which the arrow of each axis points is called “+”, and the opposite direction is called “−”. Also, the upper side of FIGS. 1 to 23 may be referred to as “upper” or “above”, and the lower side may be referred to as “lower” or “below”.

A fiber structure producing device 100 illustrated in FIG. 1 is a device for obtaining a molded body by crushing and defibrating a raw material M1, mixing a bonding material with the raw material M1, accumulating the mixture by a fibrous body accumulating device 1 to mold an accumulation thereof by a molding section 20.

The molded body produced by the fiber structure producing device 100 may be a sheet-like molded body such as recycled paper, or a block-shaped molded body. Further, a molded body having a density without limitation is used, but a molded body having a relatively high fiber density such as a sheet may be used, or a molded body having a relatively low fiber density such as a sponge body may be used, or a molded body in which these characteristics are mixed may be used.

Hereinafter, a molded body produced by using the raw material M1 as used or unnecessary used paper will be described as a sheet S which is recycled paper.

As illustrated in FIG. 1, the fiber structure producing device 100 includes a raw material supply section 11, a crushing section 12, a defibrating section 13, a sorting section 14, a first web forming section 15, a subdividing section 16, a mixing section 17, a dispersion section 18, a second web forming section 19, a molding section 20, a cutting section 21, a stock section 22, a collection section 27, and a control section 28 controlling these operations. Among these sections, the dispersion section 18 and the second web forming section 19 constitute the fibrous body accumulating device 1. The sections on upstream of the dispersion section 18, that is, the raw material supply section 11 to the mixing section 17 may be regarded as components of the fibrous body accumulating device 1.

The fiber structure producing device 100 includes a humidifying section 231, a humidifying section 232, a humidifying section 233, a humidifying section 234, a humidifying section 235, and a humidifying section 236. In addition, the fiber structure producing device 100 includes a blower 261, a blower 262, and a blower 263.

The humidifying sections 231 to 236 and the blowers 261 to 263 are electrically coupled to the control section 28, operations thereof are controlled by the control section 28. That is, in the present embodiment, a configuration in which the operation of each section in the fiber structure producing device 100 is controlled by one control section 28 is provided. However, the present disclosure is not limited to this, for example, a configuration of including a control section controlling an operation of each section in the fibrous body accumulating device 1 and a control section controlling the operations of portions other than in the fibrous body accumulating device 1 may be provided.

In the fiber structure producing device 100, a raw material supply process, a crushing process, a defibrating process, a sorting process, a first web forming process, a dividing process, a mixing process, a releasing process, an accumulating process, a sheet forming process, and a cutting process are performed in this order.

Hereinafter, the configuration of each section will be described.

The raw material supply section 11 is a portion that performs the raw material supply process of supplying the raw material M1 to the crushing section 12. The raw material M1 is a sheet-like material made of a fiber-containing material containing a cellulose fiber. The cellulose fiber may be any fibrous material containing cellulose as a main compound, and may contain hemicellulose and lignin in addition to cellulose. The form of the raw material M1 is not limited, such as woven fabric or non-woven fabric. The raw material M1 may be, for example, recycled paper recycled and manufactured by defibrating used paper, or synthetic YUPO paper (registered trademark), and may not be recycled paper.

The crushing section 12 is a portion that performs the crushing process of crushing the raw material M1 supplied from the raw material supply section 11 in the air such as the atmosphere. The crushing section 12 has a pair of crushing blades 121 and a chute 122.

The pair of crushing blades 121 rotate in the opposite direction to each other, such that the raw material M1 can be crushed, that is, cut between the pair of crushing blades 121 to obtain coarse debris M2. A shape and a size of the coarse debris M2 are preferably suitable for the defibrating process of the defibrating section 13. For example, a small piece having a side length of 100 mm or less is preferable, and a small piece having a side length of 10 mm or more and 70 mm or less is more preferable.

The chute 122 is disposed below the pair of crushing blades 121 and has, for example, a funnel shape. Therefore, the chute 122 can receive the coarse debris M2 crushed and fallen by the crushing blade 121.

The humidifying section 231 is disposed above the chute 122 so as to be adjacent to the pair of crushing blades 121. The humidifying section 231 humidifies the coarse debris M2 in the chute 122. The humidifying section 231 is configured of a vaporization type humidifier which has a filter containing moisture and supplies humidified air with increased humidity to the coarse debris M2 by passing air through the filter. By supplying the humidified air to the coarse debris M2, it is possible to suppress the coarse debris M2 from adhering to the chute 122 and the like due to static electricity.

The chute 122 is coupled to the defibrating section 13 via a pipe 241. The coarse debris M2 collected in the chute 122 passes through the pipe 241 and is transported to the defibrating section 13.

The defibrating section 13 is a portion that performs a defibrating process of defibrating the coarse debris M2 in the air, that is, in a dry method. By performing the defibrating process by the defibrating section 13, a defibrated material M3 can be generated from the coarse debris M2. Here, “defibrating” means unraveling the coarse debris M2 formed by binding a plurality of fibers into individual fibers. Then, the unraveled fibers become the defibrated material M3. The shape of the defibrated material M3 is linear or strip-shaped. Furthermore, the defibrated materials M3 may exist in a state in which they are intertwined into an aggregate, that is, in a state of forming a so-called “lump”.

In the present embodiment, for example, the defibrating section 13 is configured of an impeller mill having a rotary blade that rotates at a high speed and a liner that is located on the outer periphery of the rotary blade. The coarse debris M2 flowed into the defibrating section 13 is defibrated while being interposed between the rotor and the liner.

The defibrating section 13 can generate a flow of air from the crushing section 12 toward the sorting section 14, that is, an airflow, by rotation of the rotary blade. Accordingly, the coarse debris M2 can be sucked into the defibrating section 13 from the pipe 241. After the defibrating process, the defibrated material M3 can be sent out to the sorting section 14 via a pipe 242.

The blower 261 is installed in the middle of the pipe 242. The blower 261 is an airflow generator that generates an airflow toward the sorting section 14. Accordingly, the sending out of the defibrated material M3 to the sorting section 14 is promoted.

The sorting section 14 is a portion that performs a sorting process of sorting the defibrated material M3 according to the length of the fibers. In the sorting section 14, the defibrated material M3 is sorted into a first sorted material M4-1 and a second sorted material M4-2 longer than the first sorted material M4-1. The first sorted material M4-1 has a size suitable for the subsequent manufacture of the sheet S. The average length of the first sorted material M4-1 is preferably 1 μm or more and 30 μm or less. On the other hand, the second sorted material M4-2 includes, for example, those in which fibers are insufficiently defibrated or those in which the defibrated fibers are excessively aggregated.

The sorting section 14 has a drum section 141 and a housing 142 that houses the drum section 141.

The drum section 141 is a sieve that is formed of a cylindrical net body and rotates about its central axis. The defibrated material M3 flows into the drum section 141. As the drum section 141 rotates, the defibrated material M3 smaller than a mesh opening of the net is sorted as the first sorted material M4-1, and the defibrated material M3 larger than the mesh opening of the net is sorted as the second sorted material M4-2.

The first sorted material M4-1 falls from the drum section 141.

On the other hand, the second sorted material M4-2 is sent out to a pipe 243 coupled to the drum section 141. The pipe 243 is coupled to the pipe 241 on the opposite side of the drum section 141, that is, on the upstream. The second sorted material M4-2 passed through the pipe 243 merges with the coarse debris M2 in the pipe 241 and flows into the defibrating section 13 with the coarse debris M2. As a result, the second sorted material M4-2 is returned to the defibrating section 13 and is subjected to the defibrating process with the coarse debris M2.

The first sorted material M4-1 that has fallen from the drum section 141 falls while being dispersed in the air and directs towards the first web forming section 15 located below the drum section 141. The first web forming section 15 is a portion that performs a first web forming process of forming a first web M5 from the first sorted material M4-1. The first web forming section 15 has a mesh belt 151, three stretching rollers 152, and a suction section 153.

The mesh belt 151 is an endless belt, and the first sorted material M4-1 is accumulated thereon. The mesh belt 151 is wound around the three stretching rollers 152. Then, the first sorted material M4-1 on the mesh belt 151 is transported downstream by the rotation of the stretching roller 152.

The first sorted material M4-1 has a size larger than the mesh opening of the mesh belt 151. As a result, the first sorted material M4-1 is restricted from passing through the mesh belt 151, and can thus be accumulated on the mesh belt 151. Further, the first sorted material M4-1 is transported downstream along with the mesh belt 151 while being accumulated on the mesh belt 151, and it is thus formed as a layered first web M5.

For example, dust and dirt may be mixed in the first sorted material M4-1. Dust and dirt may be generated due to crushing or defibration, for example. Such dust and dirt are collected in the collection section 27 to be described later.

The suction section 153 is a suction mechanism that sucks air from below the mesh belt 151. Accordingly, dust and dirt that has passed through the mesh belt 151 can be sucked together with air.

The suction section 153 is coupled to the collection section 27 via a pipe 244. The dust and dirt sucked by the suction section 153 are collected by the collection section 27.

A pipe 245 is further coupled to the collection section 27. Furthermore, the blower 262 is installed in the middle of the pipe 245. By the operation of the blower 262, a suction force can be generated in the suction section 153. As a result, the formation of the first web M5 on the mesh belt 151 is promoted. The first web M5 is one from which dust and dirt are removed. Furthermore, dust and dirt pass through the pipe 244 and reach the collection section 27 by the operation of the blower 262.

The housing 142 is coupled to the humidifying section 232. The humidifying section 232 is configured of a vaporization type humidifier. As a result, humidified air is supplied into the housing 142. The first sorted material M4-1 can be humidified by the humidified air, thereby suppressing the first sorted material M4-1 from adhering on an inner wall of the housing 142 by an electrostatic force.

The humidifying section 235 is disposed at the downstream of the sorting section 14. The humidifying section 235 is configured of an ultrasonic humidifier that sprays water. Accordingly, moisture can be supplied to the first web M5, thereby adjusting the moisture content of the first web M5. With this adjustment, it is possible to suppress adsorption of the first web M5 to the mesh belt 151 by the electrostatic force. As a result, the first web M5 is easily peeled off from the mesh belt 151 at a position where the mesh belt 151 is folded back by the stretching roller 152.

The subdividing section 16 is disposed at the downstream of the humidifying section 235. The subdividing section 16 is a portion that performs a dividing process of dividing the first web M5 peeled off from the mesh belt 151. The subdividing section 16 has a propeller 161 that is rotatably supported and a housing 162 that houses the propeller 161. The first web M5 can be divided by the rotating propeller 161. The divided first web M5 becomes a subdivided body M6. Furthermore, the subdivided body M6 descends in the housing 162.

The housing 162 is coupled to the humidifying section 233. The humidifying section 233 is configured of a vaporization type humidifier. As a result, humidified air is supplied into the housing 162. With the humidified air, it is possible to suppress the subdivided body M6 from adhering to the propeller 161 or an inner wall of the housing 162 by the electrostatic force.

The mixing section 17 is disposed at the downstream of the subdividing section 16. The mixing section 17 is a portion that performs a mixing process of mixing the subdivided body M6 and an additive. The mixing section 17 has an additive supply section 171, a pipe 172, and a blower 173.

The pipe 172 couples the housing 162 of the subdividing section 16 and a housing 182 of the dispersion section 18, and is a path through which a mixture M7 of the subdivided body M6 and the additive passes.

The additive supply section 171 is coupled in the middle of the pipe 172. The additive supply section 171 has a housing 170 in which the additive is stored, and a screw feeder 174 provided in the housing 170. The additive in the housing 170 is extruded from the housing 170 and supplied into the pipe 172 by the rotation of the screw feeder 174. The additive supplied into the pipe 172 is mixed with the subdivided body M6 to obtain the mixture M7.

Here, examples of the additive supplied from the additive supply section 171 can include a binder for binding fibers to each other, a coloring agent for coloring fibers, an aggregation inhibitor for inhibiting aggregation of fibers, a flame retardant for making fibers and the like difficult to burn, a paper strengthening agent for enhancing paper strength of the sheet S, a defibrated material, and the like. Among them, one or a plurality of additives can be used in combination. In the following, a case where the additive is a resin P1 as a binder will be described as an example. The additive includes a binder for binding fibers to each other, such that the strength of the sheet S can be enhanced.

As the resin P1, a powder resin or a particulate resin can be used. For example, as the resin P1, a thermoplastic resin, a curable resin, and the like can be used, but a thermoplastic resin is preferably used. Examples of thermoplastic resin include AS resin; ABS resin; polyolefin such as polyethylene, polypropylene, and ethylene-vinyl acetate copolymer; modified polyolefin; acrylic resin such as polymethyl methacrylate; polyester such as polystyrene, polyethylene terephthalate, and polybutylene terephthalate; polyamide such as nylon 6, nylon 46, nylon 66, nylon 610, nylon 612, nylon 11, nylon 12, nylon 6-12, and nylon 6-66; polyphenylene ether; polyacetal; polyether; polyphenylene oxide; polyether ether ketone; polycarbonate; polyphenylene sulfide; thermoplastic polyimide; polyether imide; liquid crystal polymer such as aromatic polyester; and various thermoplastic elastomers such as styrene-based elastomer, polyolefin-based elastomer, polyvinyl chloride-based elastomer, polyurethane-based elastomer, polyester-based elastomer, polyamide-based elastomer, polybutadiene-based elastomer, trans-polyisoprene-based elastomer, fluororubber-based elastomer, and chlorinated polyethylene-based elastomer. One or more of these materials selected therefrom may be used independently or in combination. As the thermoplastic resin, polyester or a resin containing these materials is preferably used.

In the middle of the pipe 172, the blower 173 is installed downstream of the additive supply section 171. Mixing of the subdivided body M6 and the resin P1 by an action of a rotation section such as a blade of the blower 173 is promoted. Furthermore, the blower 173 can generate airflow toward the dispersion section 18. With this airflow, the subdivided body M6 and the resin P1 can be stirred in the pipe 172. As a result, the mixture M7 can be transported into the dispersion section 18 in a state in which the subdivided body M6 and the resin P1 are uniformly dispersed. Furthermore, the subdivided body M6 in the mixture M7 is loosened during passing through the pipe 172 and becomes a finer fibrous.

As illustrated in FIG. 2, an end portion of the pipe 172 on the drum 181 side is branched into two forks, and the branched end portions are coupled to introduction ports 180 of the drum 181, respectively.

The dispersion section 18 illustrated in FIGS. 1 to 4 is a portion that performs a releasing process of loosening and releasing the mutually intertwined fibers in the mixture M7. The dispersion section 18 includes the drum 181 that introduces and releases the mixture M7 which is a defibrated material, the housing 182 that houses the drum 181, and a drive source 183 that rotates the drum 181.

The drum 181 is a sieve that is formed of a cylindrical net body and rotates about its central axis O181. The introduction ports 180 are formed on both end surfaces of the drum 181, and the branched end portions of the pipe 172 are coupled to the introduction ports 180, respectively. As a result, the mixture M7 is introduced into the drum 181 via the introduction port 180. Then, when the drum 181 rotates, fibers and the like smaller than the mesh opening of the net in the mixture M7 can pass through the drum 181. At that time, the mixture M7 is loosened and released. That is, the mesh of net of the drum 181 functions as an opening for releasing the material containing the fiber.

As described above, the drum 181 has the introduction ports 180 for introducing the mixture M7, which is a material, on both sides of the drum 181 in a direction along the central axis O181. With such a configuration, as illustrated in FIG. 8, the airflow collides near the central portion, and lumps and aggregates of the mixture M7 are likely to be formed in the portion. Therefore, as will be described later, it is advantageous to have a first portion 31A located at a central portion of a first dispersion member 31.

Although not illustrated, the drive source 183 includes a motor, a reduction gear, and a belt. The motor is electrically coupled to the control section 28 via a motor driver. A rotational force output from the motor is reduced by the reduction gear. The belt is configured of, for example, an endless belt, and is wound around an output shaft of the reduction gear and an outer circumference of the drum. As a result, the rotational force of the output shaft of the reduction gear is transmitted to the drum 181 via the belt.

The housing 182 is coupled to the humidifying section 234. The humidifying section 234 is configured of a vaporization type humidifier. As a result, humidified air is supplied into the housing 182. The humidified air can humidify the inside of the housing 182, and therefore, it is possible to suppress the mixture M7 from adhering to an inner wall of the housing 182 by the electrostatic force.

The mixture M7 released in the drum 181 falls while being dispersed in the air, and directs towards the second web forming section 19 located below the drum 181. The second web forming section 19 is a portion for performing an accumulation process of accumulating the mixture M7 to form a second web M8 which is an accumulation. The second web forming section 19 has a mesh belt 191, stretching rollers 192, and a suction section 193.

The mesh belt 191 is a mesh member, and in the configuration illustrated in FIG. 1, is configured of an endless belt. Further, the mixture M7 dispersed and released by the dispersion section 18 is accumulated on the mesh belt 191. The mesh belt 191 is wound around four stretching rollers 192. Then, the mixture M7 on the mesh belt 191 is transported downstream by the rotation of the stretching roller 192.

Most of the mixture M7 on the mesh belt 191 has a size larger than the mesh opening of the mesh belt 191. As a result, the mixture M7 can be restricted from passing through the mesh belt 191, thereby being accumulated on the mesh belt 191. Furthermore, the mixture M7 is transported downstream along with the mesh belt 191 while being accumulated on the mesh belt 191, and it is thus formed as a layered second web M8.

The suction section 193 is a suction mechanism that sucks air from below the mesh belt 191. Accordingly, the mixture M7 can be sucked on to the mesh belt 191, thereby promoting the mixture M7 being accumulated on the mesh belt 191.

A pipe 246 is coupled to the suction section 193. Furthermore, the blower 263 is installed in the middle of the pipe 246. By the operation of the blower 263, a suction force can be generated in the suction section 193.

The humidifying section 236 is disposed at the downstream of the dispersion section 18. The humidifying section 236 is configured of an ultrasonic humidifier similar to the humidifying section 235. As a result, moisture can be supplied to the second web M8, thereby adjusting the moisture content of the second web M8. With this adjustment, it is possible to suppress adsorption of the second web M8 to the mesh belt 191 by the electrostatic force. As a result, the second web M8 is easily peeled off from the mesh belt 191 at a position where the mesh belt 191 is folded back by the stretching roller 192.

The total content of the moisture added to the humidifying sections 231 to 236 is preferably 0.5 parts by mass or more and 20 parts by mass or less with respect to 100 parts by mass of the material before humidification, for example.

The molding section 20 is disposed at the downstream of the second web forming section 19. The molding section 20 is a portion that performs a sheet forming process of forming the sheet S from the second web M8. The molding section 20 has a pressurizing section 201 and a heating section 202.

The pressurizing section 201 has a pair of calender rollers 203 and can pressurize the second web M8 between the calender rollers 203 without heating. Accordingly, the density of the second web M8 is increased. When heating the second web M8, it is heated to some extent that the resin P1 is not melted, which is preferable. Then, the second web M8 is transported toward the heating section 202. One of the pair of calender rollers 203 is a main driving roller driven by the operation of a motor (not illustrated), and the other is a driven roller.

The heating section 202 has a pair of heating rollers 204 and can pressurize the second web M8 between the heating rollers 204 while heating the second web M8. By heating and pressurizing the second web M8, the resin P1 is melted in the second web M8, and fibers are bound to each other through the melted resin P1. As a result, the sheet S is formed. Then, the sheet S is transported toward the cutting section 21. One of the pair of heating rollers 204 is a main driving roller driven by the operation of a motor (not illustrated), and the other is a driven roller.

The cutting section 21 is disposed at the downstream of the molding section 20. The cutting section 21 is a portion that performs a cutting process of cutting the sheet S. The cutting section 21 has a first cutter 211 and a second cutter 212.

The first cutter 211 cuts the sheet S in a direction intersecting a transport direction of the sheet S, particularly, a direction orthogonal to the transport direction of the sheet S.

The second cutter 212 cuts the sheet S in a direction parallel to the transport direction of the sheet S at the downstream of the first cutter 211. This cutting is to remove unnecessary portions at both end portions of the sheet S, that is, end portions in +y axis direction and −y axis direction and to adjust the width of the sheet S. The cut and removed portion is called “edge”.

By the cutting performed with the first cutter 211 and the second cutter 212, a sheet S having a desired shape and size can be obtained. The sheet S is further transported downstream and accumulated in the stock section 22.

The molding section 20 is not limited to a configuration of molding the accumulation on the sheet S as described above, and may be a configuration of molding the accumulation into, for example, a block-shaped or spherical molded body.

As described above, each section of the fiber structure producing device 100 is electrically coupled to the control section 28. The operation of each of these sections is controlled by the control section 28.

The control section 28 has a central processing unit (CPU) 281 and a storage section 282. The CPU 281 can execute various programs stored in the storage section 282, and can perform, for example, various determinations or various instructions.

For example, various programs such as a program for manufacturing a sheet S, various calibration curves, cables, and the like are stored in the storage section 282.

The control section 28 may be incorporated in the fiber structure producing device 100, or may be provided in an external device such as an external computer. For example, the external device may communicate with the fiber structure producing device 100 via a cable or the like or in a wireless manner, for example, the external device may be coupled to the fiber structure producing device 100 via the network such as the Internet.

The CPU 281 and the storage section 282 may be integrated into a single unit. The CPU 281 may be incorporated in the fiber structure producing device 100, and the storage section 282 may be provided in an external device such as an external computer. The storage section 282 may be incorporated in the fiber structure producing device 100, and the CPU 281 may be provided in an external device such as an external computer.

Meanwhile, as illustrated in FIGS. 2 and 3, the first dispersion member 31 and a second dispersion member 32 are provided in the drum 181 of the dispersion section 18. The first dispersion member 31 and the second dispersion member 32 disperse the mixture M7 by colliding with the mixture M7 in the drum 181. Here, the dispersion of the mixture M7 performed by the first dispersion member 31 and the second dispersion member 32 means stirring the mixture M7 while loosening in the drum 181, particularly, contacting lumps and aggregates contained in the mixture M7 with the first dispersion member 31 and the second dispersion member 32 to crush and make them finer.

The first dispersion member 31 is disposed in the drum 181 and at a position unevenly distributed vertically below the central axis O181. When the center of gravity of the first dispersion member 31 is located vertically below the central axis O181, it is assumed that the first dispersion member 31 is disposed at a position unevenly distributed vertically below the central axis O181 even though a part of the first dispersion member 31 is located vertically above the central axis O181.

As described above, the first dispersion member 31 is disposed at a position unevenly distributed vertically below the central axis O181. As a result, the mixture M7 collides with the first dispersion member 31 at a position vertically below the drum 181 in which the mixture M7 is easily collected and lumps and aggregates are likely to be generated, such that the mixture M7 can be efficiently dispersed. Therefore, the uniform release of the mixture M7 from the drum 181 can be promoted.

The first dispersion member 31 has an elongated shape extending along the central axis O181 of the drum 181, that is, along the y axis direction. As a result, the first dispersion member 31 can satisfactorily disperse the mixture M7 over a wide range in the longitudinal direction of the drum 181. The first dispersion member 31 has a plate shape having a pair of main surfaces 311 which are in a front-to-back relationship with each other.

As illustrated in FIG. 2, both end portions of the first dispersion member 31 are fixed and supported on side walls of the housing 182. Therefore, the first dispersion member 31 does not rotate with the rotation of the drum 181. That is, even when the drum 181 rotates, the first dispersion member 31 remains at an installation position. As a result, the mixture M7 that moves in the drum 181 with the rotation of the drum 181 can reliably collide with and be dispersed by the first dispersion member 31. That is, a dispersion efficiency can be further improved.

Further, the first dispersion member 31 has a plate shape. That is, the first dispersion member 31 has a plate shape having a pair of main surfaces 311 which are in a front-to-back relationship with each other. A first portion 31A and a second portion 31B are disposed to be separated from the inner peripheral surface 184 of the drum 181. As a result, the mixture M7 can pass between the first dispersion member 31 and the inner peripheral surface 184 of the drum 181. At that time, since the mixture M7 collides with an edge portion of the first dispersion member 31, the mixture M7 can be more effectively dispersed. Further, the drum 181 can be smoothly rotated.

As illustrated in FIG. 4, the first dispersion member 31 is provided such that the main surface 311 is inclined with respect to a movement direction of the inner peripheral surface 184 of the drum 181. That is, the first dispersion member 31 has a plate shape, and a normal line 312 of the main surface 311 is installed so as to be inclined with respect to a straight line 185 along a radial direction of the drum 181. Note that, the normal line 312 is a straight line passing through the center of the main surface 311 and the straight line 185 is a straight line passing through the center of the first dispersion member 31. As a result, the mixture M7 can easily collide with the main surface 311. Therefore, the mixture M7 can be loosened, particularly, dispersed more efficiently.

As illustrated in FIG. 4, an angle θ1 formed by the normal line 312 and the straight line 185 is preferably 3° or more and 60° or less, and more preferably 10° or more and 40° or less. As a result, the mixture M7 can easily collide with the main surface 311. Therefore, the mixture M7 can be loosened more effectively.

The first dispersion member 31 is provided on a front side of a portion 186 that is most vertically downward in the drum 181 in a rotation direction of the drum 181. That is, as illustrated in FIG. 4, when the drum 181 rotates clockwise when viewed from the y axis direction, the first dispersion member 31 is located on a −x axis side of the central axis O181 of the drum 181 and on a −z axis side when viewed from a direction along the central axis O181 of the drum. As a result, the mixture M7 can be guided toward the second dispersion member 32 in a loosened state, which will be described later. When the drum 181 rotates counterclockwise when viewed from the y axis direction, the first dispersion member 31 is preferably located on the +x axis side of the central axis O181 of the drum 181 and on the −z axis side when viewed from a direction along the central axis O181 of the drum.

As described above, the fibrous body accumulating device 1 includes the first dispersion member 31 that is disposed at a position in the drum 181 unevenly distributed vertically below the central axis O181, and disperses the mixture M7 in the drum 181. Specifically, a portion of the first dispersion member 31 that is closest to the inner peripheral surface 184 of the drum 181 is located in the drum 181 and at a position unevenly distributed vertically below the central axis O181. As a result, the mixture M7 collides with the first dispersion member 31 at a position vertically below the drum 181 in which the mixture M7 is easily collected and lumps are likely to be generated, such that the mixture M7 can be stirred and dispersed. Therefore, it is possible to efficiently prevent or suppress the formation of lumps of the mixture M7 in the drum 181 and promote uniform release of the mixture M7 from the drum 181. As a result, a thickness of the second web M8 can be made uniform as possible, and the quality of the second web M8 can be improved.

Next, the second dispersion member 32 will be described.

As illustrated in FIGS. 2 to 4, the second dispersion member 32 is disposed in the drum 181 and at a position unevenly distributed vertically above the central axis O181 of the drum 181. The second dispersion member 32 has a function of dispersing the mixture M7 by colliding with the mixture M7 in the drum 181 and a function of guiding the mixture M7 in the drum 181 vertically downward to promote the release of the mixture M7.

As illustrated in FIGS. 2 and 3, the second dispersion member 32 has an elongated shape extending along the central axis O181 of the drum 181, that is, along the y axis direction. The second dispersion member 32 has a plate shape having a pair of main surfaces 321 which are in a front-to-back relationship with each other.

Further, both end portions of the second dispersion member 32 are fixed and supported on the side walls of the housing 182. Therefore, the second dispersion member 32 does not rotate with the rotation of the drum 181. That is, even when the drum 181 rotates, the second dispersion member 32 remains at an installation position. As a result, the mixture M7 that moves in the drum 181 with the rotation of the drum 181 can reliably collide by the second dispersion member 32. Therefore, the mixture M7 can be loosened more effectively, and the mixture M7 can be guided vertically downward in the drum 181.

The second dispersion member 32 has an elongated shape extending along the central axis O181 of the drum 181. As a result, the second dispersion member 32 can satisfactorily disperse the mixture M7 over a wide range in a longitudinal direction of the drum 181 and guide the mixture M7 vertically downward in the drum 181.

Further, the second dispersion member 32 has a plate shape. That is, the second dispersion member 32 has a plate shape having a pair of main surfaces 321 which are in a front-to-back relationship with each other. The second dispersion member 32 is disposed to be separated from an inner peripheral surface 184 of the drum 181. As a result, the mixture M7 can pass between the second dispersion member 32 and the inner peripheral surface 184 of the drum 181. At that time, since the mixture M7 collides with an edge portion of the second dispersion member 32, the mixture M7 can be more effectively dispersed. As a result, the mixture M7 can be loosened more effectively.

As illustrated in FIG. 4, a separation distance D3, which is the shortest separation distance between the second dispersion member 32 and the inner peripheral surface 184 of the drum 181, is not particularly limited, and for example, is preferably 15 mm or more and 200 mm or less, and more preferably 25 mm or more and 120 mm or less. As a result, the second dispersion member 32 can effectively guide the mixture M7 vertically downward in the drum 181.

The second dispersion member 32 is provided such that the main surface 321 is inclined with respect to a movement direction of the inner peripheral surface 184 of the drum 181. That is, the second dispersion member 32 has a plate shape, and a normal line 322 of the main surface 321 is installed so as to be inclined with respect to a straight line 187 along a radial direction of the drum 181. Note that, the normal line 322 is a straight line passing through the center of the main surface 321 and the straight line 187 is a straight line passing through the center of second dispersion member 32. As a result, the mixture M7 can easily collide with the main surface 311. Therefore, the mixture M7 can be loosened more effectively, and the mixture M7 can be effectively guided vertically downward in the drum 181.

An angle θ2 formed by the normal line 322 and the straight line 187 is preferably smaller than the angle θ1 described above. As a result, the main surface 321 of the second dispersion member 32 on the vertically downward side faces vertically downward, and the mixture M7 can be more effectively guided to the vertically downward side in the drum 181.

The angle θ2 is preferably 2° or more and 55° or less, and more preferably 5° or more and 35° or less. As a result, the mixture M7 can be more effectively guided to the vertically downward side in the drum 181.

As described above, the fibrous body accumulating device 1 includes the second dispersion member 32 that is disposed in the drum 181 and at a position unevenly distributed vertically above the central axis O181, and disperses the mixture M7, which is a material in the drum 181. As a result, the second dispersion member 32 can more effectively disperse the mixture M7 due to a synergistic effect with the first dispersion member 31, and can guide the mixture M7 in the drum 181 vertically downward to promote the release of the mixture M7.

Specifically, as illustrated in FIG. 5, even when lumps of the mixture M7 is formed, a part of the lumps passes between the first dispersion member 31 and the inner peripheral surface 184 of the drum 181 and dispersed, and the remaining part is dispersed by the main surface 311 of the first dispersion member 31. As illustrated in FIG. 6, a part of the lumps is more finely dispersed by passing between the second dispersion member 32 and the inner peripheral surface 184 of the drum 181, and the remaining part is more finely dispersed by the main surface 321 of the second dispersion member 32. Then, the finely dispersed mixture M7 is guided vertically downward in the drum 181. As such, since the mixture M7 is guided vertically downward in the drum 181 in a state where the lumps are loosened, more uniform release of the mixture M7 can be realized. As a result, a thickness distribution of the second web M8 in a width direction can be performed in a desired manner, for example, uniformly, and the quality of the second web M8 can be improved.

Here, as illustrated in FIG. 7, the first dispersion member 31 includes the first portion 31A having the mixture M7 with a high dispersion ability and the second portion 31B having the mixture M7 with a lower dispersion ability than the first portion 31A. As described above, the dispersion of the mixture M7 performed by the first dispersion member 31 means contacting the mixture M7 in the drum 181, particularly, lumps and aggregates in the mixture M7 by the first dispersion member 31, and loosening and scattering them. Therefore, the “dispersion ability” refers to an ability to scatter the mixture M7 by the first dispersion member 31. When the dispersion ability is high, an existing ratio of the mixture M7 around the portion, particularly, immediately below the portion is low. When the dispersion ability is low, the existing ratio of the mixture M7 around the portion, particularly, immediately below the portion is high. As a result, it tends to show that an amount of the mixture M7 released from the portion of the drum 181 near the portion having a “high” dispersion ability may be less than an amount of the mixture M7 released from the portion of the drum 181 near the portion having a “low” dispersion ability.

In the first dispersion member 31, the first portion 31A having the mixture M7 with a high dispersion ability and the second portion 31B having the mixture M7 with a lower dispersion ability than the first portion 31A are disposed in a direction along the central axis O181, that is, at different positions in the y axis direction. In the present embodiment, the second portion 31B, the first portion 31A, and the second portion 31B are disposed side by side in this order from a +y axis side.

In the present embodiment, a difference in dispersion ability can be shown by making widths of the first portion 31A and the second portion 31B in the first dispersion member 31, that is, the separation distances from the inner peripheral surface 184 of the drum 181 different. Specifically, as illustrated in FIG. 7, D1<D2, where the separation distance between the first portion 31A and the inner peripheral surface 184 of the drum 181 is D1, and the separation distance between the second portion 31B and the inner peripheral surface 184 of the drum 181 is D2. In particular, 1.1·D1≤D2 is preferable, and 1.3·D1≤D2≤5·D1 is more preferable. In this way, the difference in dispersion abilities of the first portion 31A and the second portion 31B can be more remarkably shown by making the widths of the portions through which the mixture M7 pass different. Further, the difference in dispersion abilities can be shown by a simple configuration of the difference in widths of the first portion 31A and the second portion 31B in the first dispersion member 31.

The dimensions of D1 and D2 are not particularly limited, and for example, when an inner diameter of the drum 181 is 300 mm to 1,000 mm, the following dimensions are preferable.

D1 is preferably 5 mm or more and 100 mm or less, and more preferably 10 mm or more and 50 mm or less. D2 is preferably 10 mm or more and 150 mm or less, and more preferably 20 mm or more and 100 mm or less. D1 and D2 are set in such a numerical range, such that the difference in dispersion abilities of the first portion 31A and the second portion 31B is sufficiently increased while remarkably showing the dispersion abilities of the first portion 31A and the second portion 31B.

As illustrated in FIG. 7, the longitudinal direction of the first dispersion member 31, that is, a length L1 of the first portion 31A in the y axis direction is preferably 10% or more and 90% or less, and more preferably 20% or more and 50% or less of a length L of the first dispersion member 31 in the y axis direction. As a result, satisfactory dispersion can be performed in the first portion 31A regardless of the amount of mixture M7 introduced into the drum 181.

Further, the width of the first dispersion member 31 is constant in the first portion 31A and the second portion 31B. An edge portion of the first portion 31A on the −z axis side is linear along the y axis direction, and an edge portion of the second portion 31B on the −z axis side is also linear along the y axis direction. However, the present disclosure is not limited to such a configuration, and the edge portion of the first portion 31A on the −z axis side may be inclined with respect to the y axis or may have a curved shape. The edge portion of the second portion 31B on the −z axis side may also be inclined with respect to the y axis, or may have a curved shape.

In the first dispersion member 31, the second portion 31B, the first portion 31A, and the second portion 31B are disposed side by side in this order from the +y axis side. That is, the first portion 31A is located at the central portion in the direction along the central axis O181, and the second portion 31B is located on both sides of the first portion 31A. Here, since the mixture M7 is introduced into the drum 181 from the introduction ports 180 provided on the both sides in the y axis direction while being carried by an air flow as illustrated in FIG. 2, the air flow collides near the central portion, and the mixture M7 is thus easily collected in the corresponding portion, and furthermore, the lumps and the aggregates in the mixture M7 are easily formed, as illustrated in FIG. 8. If the first dispersion member 31 is omitted, as indicated by a broken line in FIG. 10, a thickness of the central portion of the second web M8 in the y axis direction tends to increase. In view of this, the first portion 31A is located at the central portion in the direction along the central axis O181, and the second portion 31B is located on the both sides of the first portion 31A, and thus the lumps and the aggregates in the mixture M7 formed at the central portion can be intensively dispersed and scattered around the portions as illustrated in FIG. 9. Therefore, as indicated by a solid line in FIG. 10, the unevenness of the thickness of the second web M8 in the y axis direction can be uniformized. As a result, it is possible to obtain the second web M8 having a desired thickness distribution, particularly, a uniform thickness.

In the present embodiment, such a configuration is made because the mixture M7 is easily collected at the central portion of the drum 181. However, when a configuration in which the mixture M7 is easily collected at other portions of the drum 181 is made, tendency of the configuration is grasped to prepare the first dispersion member 31 at the portion so as to have a shape corresponding to the first portion 31A, and thus the second web M8 having a desired thickness distribution can be obtained according to characteristics of the drum 181.

For example, when the mixture M7 is evenly present in the drum 181 in the y axis direction, the mixture M7 can be preferentially released from the drum 181 in the first portion 31A. As a result, the second web M8 having a desired thickness distribution can be obtained by appropriately setting shapes and arrangement positions of the first portion 31A and the second portion 31B in the first dispersion member 31. That is, the first dispersion member 31 also functions as an adjusting member for adjusting the thickness distribution of the second web M8.

As described above, the fibrous body accumulating device 1 includes a drum 181 having an opening for releasing the mixture M7 which is a material containing fibers and rotating around the central axis O181, and the first dispersion member 31 disposed in the drum 181, extending in the direction along the central axis O181, and dispersing the mixture M7 in the drum 181. The first dispersion member 31 has the first portion 31A having the mixture M7 with a high dispersion ability and the second portion 31B having the mixture M7 with a lower dispersion ability than the first portion 31A, the first portion 31A and the second portion 31B being disposed at different positions in the direction along the central axis O181. By including the first dispersion member 31, the mixture M7 in the drum 181 can collide with the first dispersion member 31 to disperse the mixture M7. Therefore, it is possible to promote the release of the mixture M7 from the opening of the drum 181. In particular, the first dispersion member 31 has the first portion 31A and the second portion 31B, such that the mixture M7 dispersed in the first portion 31A having a high dispersion ability is scattered around, particularly, to the second portion 31B side. Therefore, the amount of the mixture M7 released in the direction along the central axis O181 of the drum 181 can be adjusted by appropriately selecting the arrangement positions of the first portion 31A and the second portion 31B. As a result, the thickness distribution can be adjusted in the width direction of the second web M8.

Further, the first portion 31A and the second portion 31B may be configured of separate members and may be detachably attached to each other. In this case, the positions of the first portion 31A and the second portion 31B in the first dispersion member 31 are appropriately changed according to the characteristics of the drum 181 by assembling the first portion 31A and the second portion 31B in a desired arrangement.

The fiber structure producing device 100 includes the above-described fibrous body accumulating device 1 and a molding section 20 molding the mixture M7 which is an accumulation formed by the fibrous body accumulating device 1. The second web M8 having a desired thickness distribution and formed by the fibrous body accumulating device 1 is molded, such that a fiber structure having a desired strength distribution, that is, the sheet S can be obtained.

The configuration in which the both end portions of the first dispersion member 31 and the second dispersion member 32 are fixed and supported on the side walls of the housing 182 has been described, but the present disclosure is not limited to this, and one end portions of the first dispersion member 31 and the second dispersion member 32 may be fixed and supported on the side walls of the housing 182.

Further, the configuration in which the first dispersion member 31 and the second dispersion member 32 have a plate shape has been described, but the present disclosure is not limited to this, and may be any shape such as a rod shape or a comb-teeth shape.

### Second Embodiment

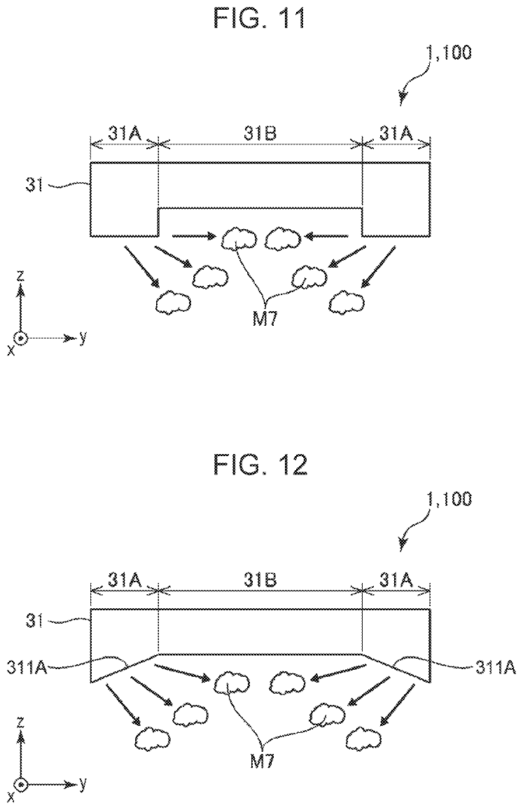

FIG. 11 is a plan view of a first dispersion member included in a fibrous body accumulating device according to a second embodiment.

Hereinafter, the second embodiment of the fibrous body accumulating device and the fiber structure producing device of the present disclosure will be described with reference to FIG. 11. Differences from the first embodiment will be mainly described, and description of similar matters will be omitted.

As illustrated in FIG. 11, the first dispersion member 31 has two first portions 31A and a second portion 31B. In the first dispersion member 31, the first portion 31A, the second portion 31B, and the first portion 31A are disposed side by side in this order from a +y axis side. That is, the second portion 31B is located at the central portion, and the first portions 31A are located on both sides of the second portion 31B.

With such a configuration, the dispersion ability at both end portions of the first dispersion member 31 in the longitudinal direction can be increased, and the dispersion ability at the central portion of the first dispersion member 31 can be reduced. Therefore, the mixture M7 dispersed into the both end portions of the first dispersion member 31 is radially scattered and collected in the central portion. As a result, although not illustrated, the thickness of the obtained second web M8 becomes larger at the central portion in the width direction, that is, in the y axis direction.

According to the present embodiment, it is advantageous when it is desired to obtain the second web M8 having a large thickness at the central portion in the y axis direction. That is, it is advantageous when it is desired to increase the strength of the obtained sheet S at the central portion in the y axis direction.

### Third Embodiment

FIG. 12 is a plan view of a first dispersion member included in a fibrous body accumulating device according to a third embodiment.

Hereinafter, the third embodiment of the fibrous body accumulating device and the fiber structure producing device of the present disclosure will be described with reference to FIG. 12. Differences from the second embodiment will be mainly described, and description of similar matters will be omitted.

In the present embodiment, the end portion of the first portion 31A of the first dispersion member 31 on the −z axis side has an inclined portion 311A inclined with respect to the y axis. Specifically, each inclined portion 311A is inclined so that a separation distance between the inclined portions 311A decreases toward the +z axis side.

With such a configuration, the same effect as that of the second embodiment can be obtained, and more mixture M7 can be collected in the central portion. Therefore, the second web M8 having a larger thickness at the central portion in the y axis direction can be obtained, and the strength of the obtained sheet S at the central portion in the y axis direction can be further increased.

### Fourth Embodiment

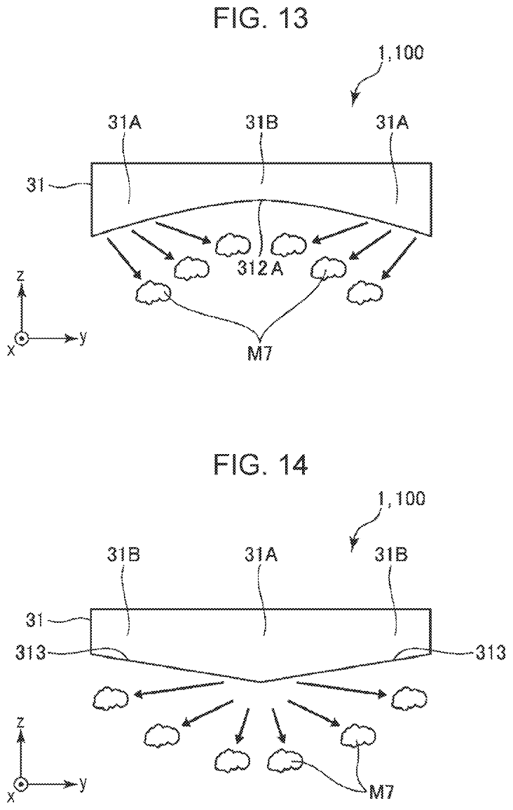

FIG. 13 is a plan view of a first dispersion member included in a fibrous body accumulating device according to a fourth embodiment.

Hereinafter, the fourth embodiment of the fibrous body accumulating device and the fiber structure producing device of the present disclosure will be described with reference to FIG. 13. Differences from the third embodiment will be mainly described, and description of similar matters will be omitted.

As illustrated in FIG. 13, the edge portion of the first dispersion member 31 on the −z axis side is curved toward the +z axis side. That is, the edge portion of each first portion 31A on the −z axis side and the edge portion of the second portion 31B on the −z axis side form a continuous curved portion 312A. In other words, there is no boundary between the first portion 31A and the second portion 31B, and a separation distance from the drum 181 (not illustrated) is changing continuously.

According to the present embodiment, the same effect as that of the third embodiment can be obtained. Furthermore, the second web M8 whose thickness distribution in the y axis direction changes smoothly can be obtained, and the sheet S whose strength distribution in the y axis direction changes smoothly can be obtained.

### Fifth Embodiment

FIG. 14 is a plan view of a first dispersion member included in a fibrous body accumulating device according to a fifth embodiment.

Hereinafter, the fifth embodiment of the fibrous body accumulating device and the fiber structure producing device of the present disclosure will be described with reference to FIG. 14. Differences from the first embodiment will be mainly described, and description of similar matters will be omitted.

As illustrated in FIG. 14, the edge portion of the first dispersion member 31 on the −z axis side has inclined portions 313 inclined in mutually opposite directions with the center of the y axis direction as a boundary. Each inclined portion 313 is inclined so that a separation distance between the inclined portions 313 increases toward the +z axis side.

According to the present embodiment, the same effect as that of the first embodiment can be obtained. Furthermore, the second web M8 whose thickness distribution in the y axis direction changes smoothly can be obtained, and the sheet S whose strength distribution in the y axis direction changes smoothly can be obtained.

### Sixth Embodiment

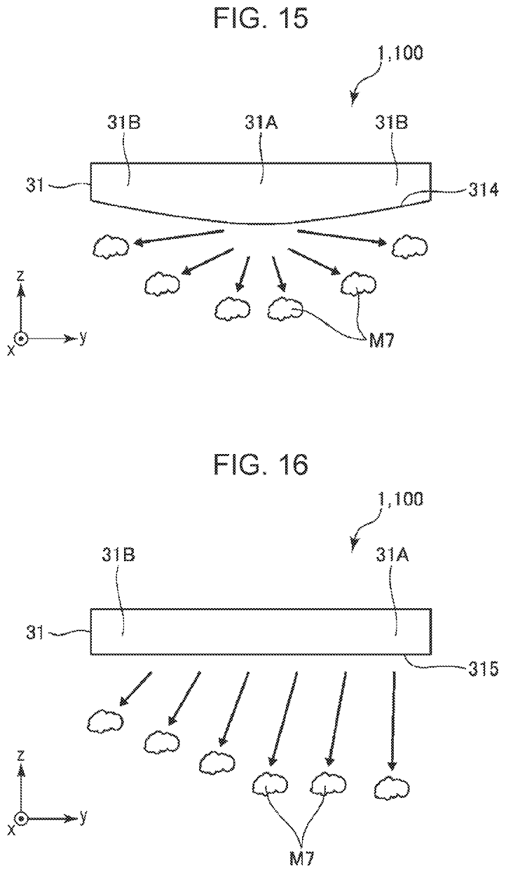

FIG. 15 is a plan view of a first dispersion member included in a fibrous body accumulating device according to a sixth embodiment.

Hereinafter, the sixth embodiment of the fibrous body accumulating device and the fiber structure producing device of the present disclosure will be described with reference to FIG. 15. Differences from the fifth embodiment will be mainly described, and description of similar matters will be omitted.

As illustrated in FIG. 15, the edge portion of the first dispersion member 31 on the −z axis side is curved toward the +z axis side. That is, the edge portion of each first portion 31A on the −z axis side and the edge portion of the second portion 31B on the −z axis side form a continuous curved portion 314. In other words, there is no boundary between the first portion 31A and the second portion 31B, and a separation distance from the inner peripheral surface 184 of the drum 181 (not illustrated) is changing continuously.

According to the present embodiment, the same effect as that of the fifth embodiment can be obtained. Furthermore, the second web M8 whose thickness distribution in the y axis direction changes more smoothly can be obtained, and the sheet S whose strength distribution in the y axis direction changes more smoothly can be obtained.

### Seventh Embodiment

FIG. 16 is a plan view of a first dispersion member included in a fibrous body accumulating device according to a seventh embodiment.

Hereinafter, the seventh embodiment of the fibrous body accumulating device and the fiber structure producing device of the present disclosure will be described with reference to FIG. 16. Differences from the above-described embodiments will be mainly described, and description of similar matters will be omitted.

As illustrated in FIG. 16, the edge portion of the first dispersion member 31 on the −z axis side has an inclined portion 315. In other words, there is no boundary between the first portion 31A and the second portion 31B, and a separation distance from the inner peripheral surface 184 of the drum 181 (not illustrated) is changing continuously. In the configuration illustrated in FIG. 16, a separation distance from the inner peripheral surface 184 of the drum 181 at the portion on the +y axis side is smaller than the separation distance from the inner peripheral surface 184 of the drum 181 at the portion on the −y axis side.

According to the present embodiment, all the mixtures M7 dispersed by the first dispersion member 31 is likely to be collected on the −y axis side, that is, on the second portion 31B side. Therefore, although not illustrated, it is advantageous when a thickness of one side of the second web M8 in the y axis direction is desired to be large and a thickness of the other side is desired to be small, and it is advantageous when the strength of one side of the sheet S in the y axis direction is desired to be increased more than the other side.

### Eighth Embodiment

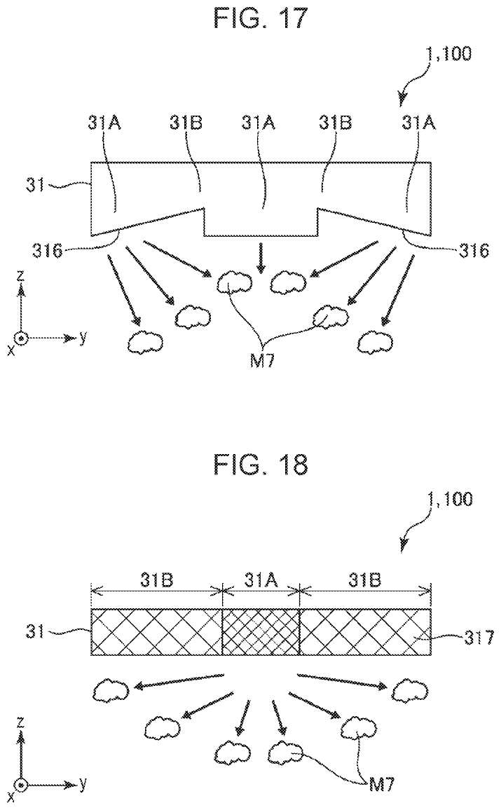

FIG. 17 is a plan view of a first dispersion member included in a fibrous body accumulating device according to an eighth embodiment.

Hereinafter, the eighth embodiment of the fibrous body accumulating device and the fiber structure producing device of the present disclosure will be described with reference to FIG. 17. Differences from the above-described embodiments will be mainly described, and description of similar matters will be omitted.

As illustrated in FIG. 17, in the first dispersion member 31, the first portion 31A, the second portion 31B, the first portion 31A, the second portion 31B, and the first portion 31A are disposed side by side in this order from the +y axis side. That is, a plurality of the first portions 31A and the second portions 31B are alternately disposed side by side. As a result, the mixture M7 can be evenly dispersed over the entire region in the y axis direction. Although not illustrated, in the second web M8, a thick portion and a thin portion can be alternately formed in the y axis direction. Further, in the sheet S, a plurality of portions having a high strength can be formed in the y axis direction.

Further, the inclined portion 316 is formed at both end portions of the first dispersion member 31 in the y axis direction so that the end portion on the −z axis side is inclined to the first portion 31A at the central portion. Each inclined portion 316 is inclined so that the separation distance between the inclined portions 316 decreases toward the +z axis side. As a result, the mixture M7 at both end sides of the first dispersion member 31 in the y axis direction can be collected on the first portion 31A side at the central portion. Therefore, in addition to having the above-mentioned characteristics, although not illustrated, the thickness of the second web M8 at the central portion becomes larger, and the strength of the sheet S at the central portion can be further increased.

### Ninth Embodiment

FIG. 18 is a plan view of a first dispersion member included in a fibrous body accumulating device according to a ninth embodiment.

Hereinafter, the ninth embodiment of the fibrous body accumulating device and the fiber structure producing device of the present disclosure will be described with reference to FIG. 18. Differences from the first embodiment will be mainly described, and description of similar matters will be omitted.

As illustrated in FIG. 18, the first dispersion member 31 is composed of a plate-like body forming a mesh shape. In the first dispersion member 31, the mesh portion of the net is an opening 317 through which the mixture M7 passes. Further, in the first dispersion member 31, roughness of the mesh at the central portion in the y axis direction and roughness of the mesh at the portions on both sides of the central portion are different from each other. In the configuration illustrated in FIG. 18, the mesh at the central portion is dense and the mesh at the portions on both sides of the central portion is sparse. Thus, the central portion having the dense mesh is the first portion 31A, and the portions on both sides thereof are the second portions 31B.

In other words, the first dispersion member 31 has a plate shape and has a plurality of openings 317 formed by through-holes penetrating in a thickness direction of the first dispersion member 31. A formation density of the opening 317 in the first portion 31A is lower than the formation density of the opening 317 in the portions on both sides of the second portion 31B. In such a first dispersion member 31, the amount of the mixture M7 passing through the opening of the mesh is relatively small, and the dispersion ability of the first portion 31A is high. On the other hand, in the second portion 31B, since the amount of the mixture M7 passing through the opening of the mesh is larger than that in the first portion 31A, the dispersion ability is lower than that in the first portion 31A. Therefore, as illustrated in FIG. 18, the mixture M7 dispersed in the first portion 31A tends to move toward both sides, that is, toward the second portion 31B. Therefore, as in the first embodiment, it is advantageous to form the second web M8 having a uniform thickness distribution in the y axis direction. In particular, since the difference in dispersion ability is shown due to the formation density of the opening, the separation distance from the inner peripheral surface 184 of the drum 181 (not illustrated) can be the same as that from the first portion 31A and the second portion 31B. Therefore, the installation position in the drum 181 can be easily adjusted.

### Tenth Embodiment

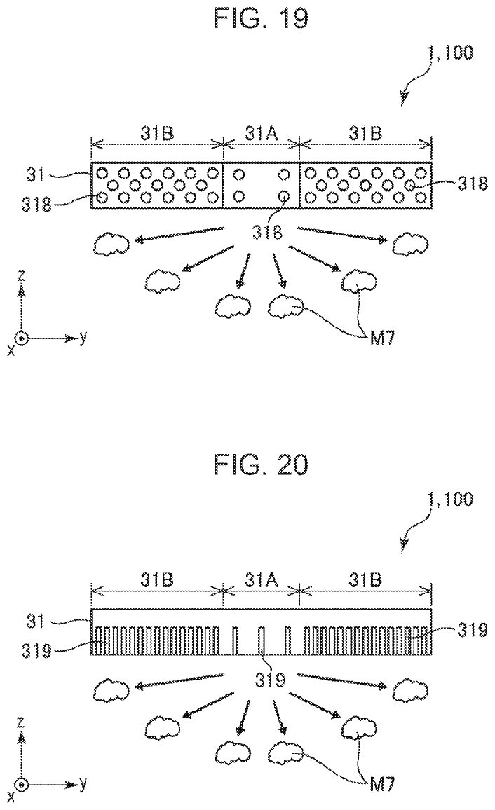

FIG. 19 is a plan view of a first dispersion member included in a fibrous body accumulating device according to a tenth embodiment.

Hereinafter, the tenth embodiment of the fibrous body accumulating device and the fiber structure producing device of the present disclosure will be described with reference to FIG. 19. Differences from the ninth embodiment will be mainly described, and description of similar matters will be omitted.

As illustrated in FIG. 19, the first dispersion member 31 is composed of a plate-like body having an opening 318 formed by through-holes. The opening 318 has a circular shape in plan view. However, the present disclosure is not limited to this configuration, and a shape of the opening 318 may be an elliptical shape, a rectangular shape, or any other shape. Further, the opening 318 in the first portion 31A at the central portion has a low formation density, and the opening 318 in the second portion 31B on both sides of the first portion 31A has a higher formation density than the first portion 31A.

In other words, the first dispersion member 31 has a plate shape and has a plurality of openings 318 formed by through-holes penetrating in a thickness direction of the first dispersion member 31. A formation density of the opening 318 in the first portion 31A is lower than the formation density of the opening 318 at both side portions of the second portion 31B. As a result, the same effect as that of the ninth embodiment can be obtained. According to the present embodiment, when a plate-like member is installed in the drum 181, the first dispersion member 31 can be obtained by a simple method such as punching the plate-like member.

### Eleventh Embodiment

FIG. 20 is a plan view of a first dispersion member included in a fibrous body accumulating device according to an eleventh embodiment.

Hereinafter, the eleventh embodiment of the fibrous body accumulating device and the fiber structure producing device of the present disclosure will be described with reference to FIG. 20. Differences from the ninth embodiment will be mainly described, and description of similar matters will be omitted.

As illustrated in FIG. 20, the first dispersion member 31 is composed of a plate-like body having comb teeth on the −z axis side. In the first dispersion member 31, there is an opening 319 between the adjacent teeth. Further, the teeth, that is, the opening 319 in the first portion 31A at the central portion has a low formation density, and the teeth, that is, the opening 319 in the second portion 31B on both sides of the first portion 31A has a higher formation density than the first portion 31A.

In other words, the first dispersion member 31 has a plate shape and has a plurality of openings 319 formed by through-holes penetrating in a thickness direction of the first dispersion member 31. A formation density of the opening 319 in the first portion 31A is lower than the formation density of the opening 319 on both side portions of the second portion 31B. As a result, the same effect as that of the ninth embodiment can be obtained. According to the present embodiment, when the plate-like member is installed in the drum 181, the first dispersion member 31 can be obtained by a simple method such as forming a plurality of slits extending in the z axis direction in the plate-like member.

### Twelfth Embodiment

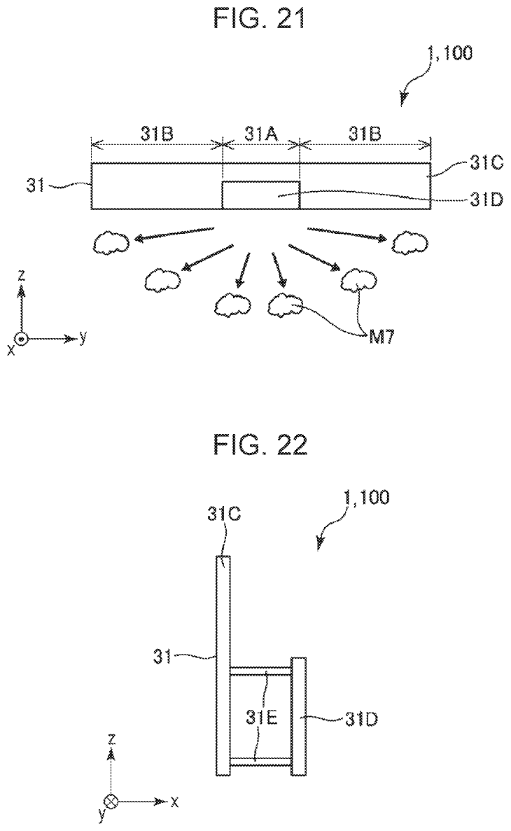

FIG. 21 is a plan view of a first dispersion member included in a fibrous body accumulating device according to a twelfth embodiment. FIG. 22 is a side view of the first dispersion member illustrated in FIG. 21.

Hereinafter, the twelfth embodiment of the fibrous body accumulating device and the fiber structure producing device of the present disclosure will be described with reference to FIGS. 21 and 22. Differences from the first embodiment will be mainly described, and description of similar matters will be omitted.

As illustrated in FIGS. 21 and 22, in the present embodiment, the first dispersion member 31 has a first plate-like body 31C, a second plate-like body 31D, connecting portions 31E connecting the first plate-like body 31C and the second plate-like body 31D. The second plate-like body 31D has a length smaller than a length of the first plate-like body 31C in the y axis direction and a length of the first plate-like body 31C in the z axis direction. The second plate-like body 31D is separated from the first plate-like body 31C on the +x axis side, and is fixed to the first plate-like body 31C through the connecting portion 31E. Further, the connecting portion 31E is fixed at a position corresponding to the central portion of the first plate-like body 31C.

According to the present embodiment, in the central portion of the first dispersion member 31, the mixture M7 collides with the second plate-like body 31D and the first plate-like body 31C in this order, and is dispersed. On the other hand, in the portions on both sides of the central portion of the first dispersion member 31, the mixture M7 collides with only the first plate-like body 31C, and is dispersed. Therefore, as the number of times of collision increases, the dispersion ability of the central portion of the first dispersion member 31 is higher than that of the portions on both sides of the central portion. Therefore, the central portion of the first dispersion member 31 functions as the first portion 31A, and the portions on both sides of the central portion function as the second portions 31B.

According to the present embodiment, the same effect as that of the first embodiment can be obtained. According to the present embodiment, when a plate-like member is installed in the drum 181, the first dispersion member 31 can be obtained by a simple method such as installing the second plate-like body 31D of the plate-like member on the +y axis side later.

### Thirteenth Embodiment

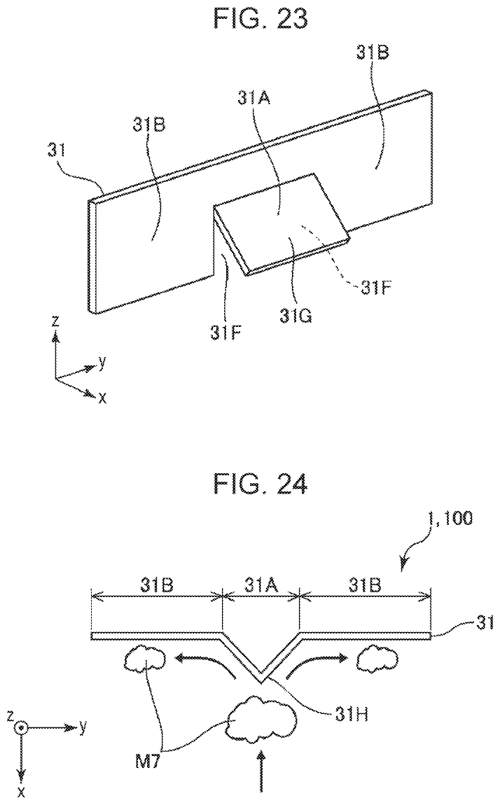

FIG. 23 is a perspective view of the first dispersion member included in the fibrous body accumulating device according to a thirteenth embodiment.

Hereinafter, the thirteenth embodiment of the fibrous body accumulating device and the fiber structure producing device of the present disclosure will be described with reference to FIG. 23. Differences from the first embodiment will be mainly described, and description of similar matters will be omitted.

As illustrated in FIG. 23, the first dispersion member 31 is formed with a pair of notches 31F that are separated from each other at the central portion in the y axis direction. The notch 31F is formed from the edge portion of the first dispersion member 31 on the −z axis side to the width direction of the first dispersion member 31, that is, in the middle of the z axis direction. Then, a portion between these notches 31F is bent to the +z axis side to form a bent portion 31G.

According to the present embodiment, in the central portion of the first dispersion member 31, first, the bent portion 31G collides with the mixture M7 (not illustrated), and then a portion of the first dispersion member 31 other than the bent portion 31G collides with the mixture M7. Accordingly, the collision occurs first, the dispersion ability of the bent portion 31G is thus higher than that of the portion other than the bent portion 31G. Therefore, the bent portion 31G in the central portion functions as the first portion 31A, and portions on both sides of the bent portion 31G function as the second portions 31B.

According to the present embodiment, the same effect as that of the first embodiment can be obtained. According to the present embodiment, when a plate-like member is installed in the drum 181, the first dispersion member 31 can be obtained by a simple method such as forming the notch 31F in the edge portion of the plate-like member on the +y axis side and forming the bent portion 31G by bending. By adjusting a bending angle of the bent portion 31G, the dispersion ability of the first portion 31A can be easily adjusted.

### Fourteenth Embodiment

FIG. 24 is a perspective view of a first dispersion member included in the fibrous body accumulating device according to a fourteenth embodiment.

Hereinafter, the fourteenth embodiment of the fibrous body accumulating device and the fiber structure producing device of the present disclosure will be described with reference to FIG. 24. Differences from the first embodiment will be mainly described, and description of similar matters will be omitted.

As illustrated in FIG. 24, in the present embodiment, a ridgeline of the bent portion 31H extends in the z axis direction, that is, the width direction of the first dispersion member 31, the bent portion 31H being bent so that the central portion of the first dispersion member 31 protrudes toward the +x axis side. According to the present embodiment, the bent portion 31H contacts the mixture M7 first, and at that time, a top portion of the bent portion 31H can efficiently disperse the mixture M7. Then, the mixture M7 can be split on both the +y axis side and the −y axis side through the top portion.

As described above, in the present embodiment, the bent portion 31H is the first portion 31A, and the portions on both sides of the first portion 31A, that is, the portions on a flat plate are the second portions 31B.

According to the present embodiment, the same effect as that of the first embodiment can be obtained. Further, when a plate-like member is installed in the drum 181, the first dispersion member 31 having the first portion 31A at the central portion and the second portions 31B on both sides of the first portion 31A can be obtained by a simple method such as bending the central portion of the plate-like member.

As described above, the fibrous body accumulating device and the fiber structure producing device of the present disclosure are described with respect to the illustrated embodiments. However, the present disclosure is not limited to this, and each portion which constitutes the fibrous body accumulating device and the fiber structure producing device can be replaced with any component that can exhibit the same function. Furthermore, any components may be added.

What is claimed is:

1. A fibrous body accumulating device, comprising:
a drum having an opening for releasing a material containing fibers and rotating around a central axis; and
a first dispersion member disposed in the drum, extending in a direction along the central axis, and dispersing the material in the drum, wherein
the first dispersion member has a first portion having the material with a high dispersion ability and a second portion having the material with a lower dispersion ability than the first portion, the first portion and the second portion being disposed at different positions in a direction along the central axis.

2. The fibrous body accumulating device according to claim 1, wherein
the first portion is located at the central portion in the direction along the central axis, and
the second portion is located on both sides of the first portion.

3. The fibrous body accumulating device according to claim 1, wherein
the first portion and the second portion are disposed to be separated from an inner peripheral surface of the drum.

4. The fibrous body accumulating device according to claim 3, wherein
D1<D2, where a separation distance between the first portion and the inner peripheral surface of the drum is D1, and a separation distance between the second portion and the inner peripheral surface of the drum is D2.

5. The fibrous body accumulating device according to claim 2, wherein
the first dispersion member has a plate shape and has a plurality of openings formed by through-holes penetrating in a thickness direction of the first dispersion member, and
a formation density of the opening in the first portion is smaller than the opening at portions on both sides of the second portion.

6. The fibrous body accumulating device according to claim 1, wherein
the first dispersion member does not rotate with the drum.

7. The fibrous body accumulating device according to claim 1, wherein
the first dispersion member is disposed at a position unevenly distributed vertically below the central axis.

8. The fibrous body accumulating device according to claim 7, wherein
the first dispersion member is provided on a front side of a portion that is most vertically downward in the drum in a rotation direction of the drum.

9. The fibrous body accumulating device according to claim 1, further comprising a second dispersion member disposed in the drum and at a position unevenly distributed vertically above the central axis, and dispersing the material in the drum.

10. The fibrous body accumulating device according to claim 1, wherein
the drum has introduction ports introducing the material and formed on both sides of the drum in a direction along the central axis.

11. A fiber structure producing device comprising:
the fibrous body accumulating device according to claim 1; and
a molding section molding an accumulation formed by the fibrous body accumulating device.
